(19) United States
(12) Patent Application Publication
(10) Pub. No.: US 2024/0430221 A1
(43) Pub. Date: Dec. 26, 2024

(54) Chatbot interfacing between a machine and users

(71) Applicant: ORANGE, Issy-Les-Moulineaux (FR)

(72) Inventors: Régis Esnault, Chatillon Cedex (FR); Thierry Martinez, Chatillon Cedex (FR); Christian Gregoire, Chatillon Cedex (FR)

(21) Appl. No.: 18/698,923

(22) PCT Filed: Oct. 5, 2022
(86) PCT No.: PCT/EP2022/077658

§ 371 Date: Apr. 5, 2024

(30) Foreign Application Priority Data
Oct. 6, 2021 (FR) FR2110582

(51) Int. Cl. H04L 51/18; G06F 40/35; H04L 51/02; H04L 51/046

(52) U.S. Cl. CPC H04L 51/18; G06F 40/35; H04L 51/02; H04L 51/046

(57) ABSTRACT

A chatbot interfacing between several devices including a machine and a plurality of user terminals running an instant messaging application in which the users converse with the chatbot by exchanging messages via their terminal. The chatbot is able to dialogue independently with the terminals and the machine. The chatbot is capable of: analyzing at least one item of content in a message of a first type sent by at least one first device; and generating a message of a second type intended for a second device on the basis of the outcome of the analysis of the message of the first type. In this case one among the first and second devices is a terminal and the other among the first and second devices is the machine.

### TECHNICAL FIELD

This invention relates to the field of instant messaging.

### PRIOR ART

A “chat room” or “live discussion space” is a virtual meeting place. Users access their respective terminals to exchange instant messages via a messaging server. In practice, the exchange of these messages is carried out by running an application installed on each user terminal. For example, a user can choose a subject of discussion according to the proposed topic or the interest of the moment, in order to converse on this subject with several participants via keyboard or voice messages. The chat room therefore typically provides a virtual meeting between several human users.

With the development of digital means of communication, particularly in the business sector, professionals who are each performing a specific task can coordinate their activity by communicating via instant messaging.

Often, however, particularly in the context of such professional activity (for example in a factory), an instant messaging discussion may concern the operation of a machine. It may be desired, for example, to control the operation of the machine appropriately after deliberation between several professionals.

There is no messaging application between several users that is capable for example of passing operating instructions to the machine. Difficulties would arise in particular when several users want to apply different operating instructions for the machine simultaneously.

This invention improves the situation.

### SUMMARY

For this purpose, it offers a computerized chat agent commonly called a “chatbot” which interfaces between at least one machine and some user terminals running an instant messaging application.

Thus, a first aspect of the invention concerns a method of communication between several devices which include a machine and a plurality of user terminals, the method being implemented by a chatbot as an interface between said several devices, the chatbot being able to communicate independently with the terminals and the machine, the terminals running an instant messaging application in which the users participate in a discussion with the chatbot by exchanging messages via their terminal.

The method comprises at least:
analyzing at least one item of content in a message of a first type sent by at least one first device, and
generating a message of a second type intended for a second device, on the basis of the results of the analysis of the message of the first type, one among the first device and second device being a terminal and the other among the first device and second device being a machine.

This invention thus makes it possible to enhance the experience of using the machine by means of a computerized chat agent (or “chatbot” hereinafter) which can communicate:
on the one hand with users in natural language and possibly coordinate their decisions, and
on the other hand with the machine in order to send it appropriate requests (for example operating instructions).

For this purpose, in one optional embodiment, the chatbot may use a knowledge base (of machine data, data relating to previous actions and comments of users, or other data).

Thus, in this embodiment, in order to formulate a message to be sent to the terminal users participating in said discussion, the chatbot, upon receiving a message of the first type coming from the machine:
accesses a knowledge database in order to identify a subject in the database linked to the content in the message of the first type coming from the machine, and
generates at least one message of the second type to be sent to at least some of the plurality of terminals, the message of the second type comprising data from the knowledge database relating to said content.

This content may relate to a type of operation in progress, or to states of the machine in a given operation, or others.

Said discussion may be planned within a professional, collaborative work setting. In this case, the knowledge database may then include information specific to a business sector of such a collaborative work setting.

For example, the messages sent by the chatbot may include information about the machine (status, current operation, alerts, lack of raw material, history, etc.), or professional tasks to be assigned to at least some of the participants in the discussion. For example, the method may include consulting the knowledge base in order to organize a sequential coordination of the professional tasks assigned to the participants, on the basis of a current state of the machine and an identification of the participants in the discussion.

Alternatively, the discussion may be planned in a collaborative setting, in an environment other than a professional work setting but with constraints specific to this other environment. For example, when the machine is a motor vehicle (or simply comprises parts of this vehicle), the safety of the people in the vehicle or around the vehicle involves constraints which may be formalized and integrated into said knowledge base.

Furthermore, the constraints related to the environment of use may not be tied to a specific machine. For example, specific rules for communicating data (for example, users' personal data) may be formalized and integrated into said knowledge base to avoid contravening a regulation concerning the protection of personal data (such as “GDPR” for example).

In one embodiment, when the message of the first type comes from at least one terminal and includes a current request to be sent to the machine, the generation of a message of the second type intended for the machine may include:
identifying said current request in the message of the first type,
consulting a knowledge database in order to determine if the current request can be sent to the machine, and, if necessary, formulating the current request in an appropriate form, in the message of the second type.

Such an implementation makes it possible for example to coordinate requests from different users, or for example to formulate an appropriate adjustment instruction for the machine based on a current state of the machine.

In one embodiment, the chatbot may apply a filtering rule to prevent sending the message of the second type to the machine, at least based on data from a transmitting terminal sending the message of the first type.

This data from the transmitting terminal may include for example a terminal identifier (a terminal number such as an IMSI, or other identifier) which identifies the terminal as belonging to a user authorized to send requests intended for the machine.

Such a request may be for example an operating instruction, or a request for an operating report or for an adjustment log, etc.

Additionally or alternatively, said data from the transmitting terminal may include current geolocation data for the transmitting terminal, and the filtering is applied if a distance between the transmitting terminal and the machine is greater than a threshold.

Additionally or alternatively, the data from the transmitting terminal may include current timestamp data sent by the transmitting terminal with the message of the first type. In this case, for example, said filtering may be applied if the current timestamp is outside a predetermined range of (usual) times of day. Additionally or alternatively, this timestamp may be used to list the different requests from terminal users in chronological order, in order to follow an appropriate sequence of operation of the machine. For example, if an instruction given to the machine contradicts a current operation, the timestamp is taken into account to determine:
if a change in operation is necessary (in the case of a recent timestamp), or
if the instruction is obsolete and was only relevant for a previous operation of the machine (in the case of a relatively old timestamp).

Additionally or alternatively, the data from the transmitting terminal includes a score from the detection of a predetermined mood, identified in the message of the first type, and filtering is applied if this score is above a threshold.

For example, if the user's message reveals anger (annoyance) or fear (hesitation) above a threshold, the chatbot may be configured not to send, for example, an instruction from the user to the machine.

For example in the case of a voice message for a message of the first type, the detection of said predetermined mood may be enhanced by a detection of voice components in said voice message (a sharper voice typically indicating anger for example).

In one embodiment, the chatbot may also apply a filtering rule to prevent sending a message of the second type to one of said plurality of terminals if that terminal is identified as belonging to a user not authorized to receive message content sent by the machine.

For example, messages that may be filtered out may be machine status messages, history messages, or other messages. The chatbot may be configured according to the type of content and for given authorizations, for example.

In one embodiment, the chatbot may analyze a message received from a terminal and/or may generate a message intended for a terminal, in natural language.

Additionally or alternatively, reciprocally the chatbot may analyze a message received from the machine and/or may generate a message intended for the machine, in formal language.

Such an embodiment allows the chatbot to interface effectively between:
the machine (a message received from the machine may include for example a machine status signal, determined from a measurement coming from at least one sensor comprised in the machine; this message may then be interpreted in formal language), and
user terminals (with which the chatbot communicates in natural language, thus improving the user experience).

According to another aspect, a computer program is proposed comprising instructions for implementing the method presented above, when this program is executed by a processor. According to another aspect, a non-transitory computer-readable storage medium is proposed, on which such a program is stored.

According to another aspect, a computing device is proposed comprising:
a communication interface for communicating with a machine on the one hand, and with a plurality of user terminals running an instant messaging application on the other hand, and
a processing circuit configured for implementing the above method.

With reference to FIG. 3, such a device DEV may include:
a first interface INT1 to be connected to a machine MA,
a second interface INT2 to be connected to user terminals TER via a virtual chat room CR (for example via a messaging server SER illustrated in FIG. 1 and discussed below), and a processing circuit comprising for example:
a memory MEM capable of storing in particular the instruction data of a computer program of the type defined above,
and a processor PROC, connected to the two interfaces INT1 and INT2, as well as to the memory MEM in order to read and execute the instructions of said computer program.

Thus, such a hardware device DEV may implement the software functionalities of a computer module such as the chatbot intervening in the method within the meaning of the invention and denoted CRB in the drawings presented below.

### BRIEF DESCRIPTION OF DRAWINGS

Other features, details, and advantages will become apparent upon reading the detailed description below, and upon analyzing the attached drawings, in which:

FIG. 1

FIG. 1 shows an example context for the implementation of a chatbot according to one embodiment of the invention.

FIG. 2

FIG. 2 shows an example of steps of a method according to one embodiment of the invention.

FIG. 3

FIG. 3 shows an example of a device implementing a chatbot according to one embodiment of the invention.

### DESCRIPTION OF EMBODIMENTS

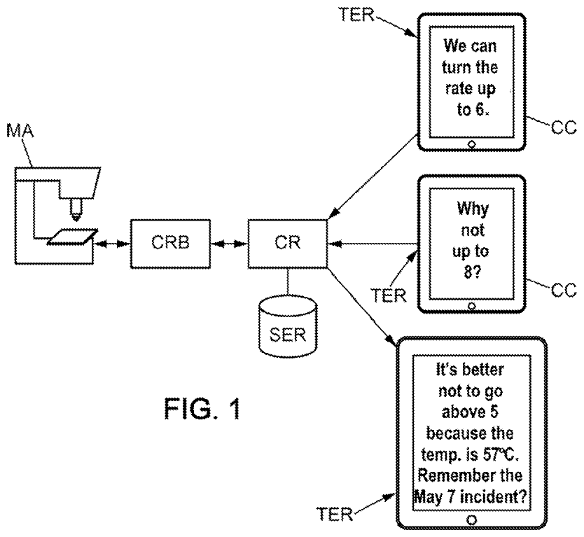

Reference is now made to FIG. 1 in which is schematically illustrated:
a machine MA,
a virtual chat room CR (for “chat room”) hosted by an instant messaging application running on user terminals TER as messaging clients CC (for “chat client”), and
a chatbot CRB (for “chat room bridge”) interfacing with the machine on the one hand, and with the virtual chat room on the other hand.

In practice, chat room CR may be implemented by a messaging server SER to which chatbot CRB and terminals TER are connected in order to exchange messages. Alternatively, chat room CR and chatbot CRB are computer modules grouped together in a same server to which are connected terminals TER on the one hand, and machine MA on the other hand.

Each user terminal TER has a human-machine interface (screen/keyboard, speaker/microphone, or other) in order to indicate received messages and/or to enter messages to send (these messages may be written, spoken, or other). Messages may thus be exchanged between users CC and also shared with chatbot CRB.

Chatbot CRB may itself also communicate with one or more of the users connected to the chat room.

Known chatbots are agents usually capable of communicating with a single user. It should be noted here that chatbot CRB is capable of communicating with several users, who may be recognized for example by a terminal identifier (IMSI for example) or an instant messaging client identifier, or even by voice in the case of exchanged voice messages, or other means. The design of such a human-machine interface is influenced by the Turing test competition and the aim is to give the illusion that a computer program is thinking, via a meaningful dialogue with one user or in this case several users. The chatbot is therefore usually intended for a dialogue between a computerized chat agent and one (or here several) user(s), who is/are individual(s). A chatbot may make use of artificial intelligence and thus, as it interacts with one or more users, enrich its knowledge base to improve the quality of its responses over time.

Chatbot CRB is noteworthy here in that it is capable of dialogue:
on the one hand with several users and possibly advising them on the basis of a history of knowledge accumulated over time, and
on the other hand with a physical device such as a machine, by representing this machine, thus enabling dialogue between users and the machine.

Chatbot CRB may make use of artificial intelligence to establish these interactions based on learning over time (possibly starting with predetermined initial rules). For example, data concerning a history of states received from the machine, and/or a history of user requests and/or of exchanges between users may be assimilated by learning in order to construct a knowledge base that chatbot

CRB exploits for interactions with users and the machine. Typically, reactions received from terminals following the reception of data from the machine can enrich the aforementioned knowledge base. This knowledge base may initially include pre-programmed data, specific to the machine and possibly to the context of its use. The chatbot may then take into account the respective levels of authorization for the users, and/or their competence and/or their experience, to weight its reactions to requests from these users.

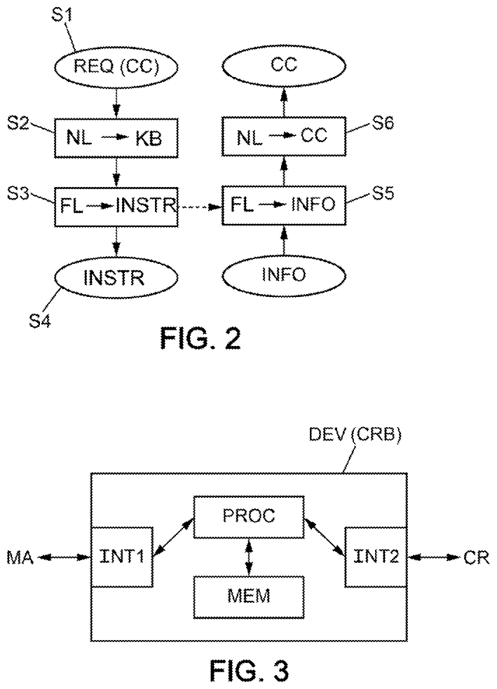

With reference to FIG. 2, chatbot CRB is therefore configured for:
implementing, in step S2, an analyzer of statements made in natural language NL (French, English, or other) in order to interpret user requests (received in a prior step S1) and then determining, by referring to knowledge base KB, a relevance and/or consistency of these requests (based for example on a current operation of the machine, an operating history of the machine, or other), and thus preparing the appropriate searches to be made concerning the machine,
formulating, in step S3 (in the formal language FL expected by the machine), the user requests to be sent to the machine in a step S4 (these may be adjustment instructions INSTR, requests for operating states of the machine, error reporting, or others),
analyzing, in a step S5 (may or may not be subsequent), the data received from the machine in formal language, as these data may not be a response to a specific request from a user: it may for example be alert messages (abnormal operation, lack of raw material, or other), then identifying in the knowledge base relevant users to send the data to, as well as a current usage context and/or a similar usage history, or other,
implementing, in a step S6, a generator of natural language statements in order to formulate (in natural language) informational messages coming from the machine and intended for relevant users CC, possibly accompanied by additional information for example about a current operation and/or events that have occurred in the past under the same conditions, or other.

Machine MA presented in FIG. 1 may be an industrial machine or more generally any piece of equipment (for example a household robot or other), capable of being supervised and/or controlled remotely by the sending of computer messages. It may provide information directly or indirectly (based on observations by a third party user), particularly concerning its current operation, upon request or at its own initiative (alerts in particular).

Typically, the machine may include one or more sensors capable of delivering signals measuring (physical) parameters, in messages received by chatbot CRB. The machine may, for example, be any factory machine (a machine tool or other), and may send the signals collectively from its sensors to chatbot CRB. Alternatively, it may be a group of machines each delivering signals from its sensors to chatbot CRB, which is then configured to aggregate these data and establish a summary for the participants in the discussion.

In an alternative setting to a work setting, a machine MA for example such as an automobile may include sensors (for coolant, brake fluid, etc.) sending information to the driver and the mechanic about these levels, via chatbot CRB. Furthermore, tire wear sensors, independent of a vehicle's on-board computer, may also transmit information to chatbot CRB about the tire wear status. Thus, for example, in coordination with the mechanic, information may be sent to the driver about an upcoming deadline for a brake fluid refill and can use this opportunity to change the tires. The term “machine” thus designates a single machine, or several parts of a same machine communicating separately with the chatbot, or even several separate machines.

More generally, the chatbot (CRB) is capable of interpreting the content of the messages returned by the machine (or returned by separate parts of the machine) in order to obtain, for example, data on the machine status, or information about the current operation of the machine, or other information. Chatbot CRB may further deduce, from the messages received from machine MA, knowledge which can enrich the aforementioned knowledge base, by storing this knowledge data in a memory (in a formalism specific to it). Chatbot CRB can thus interpret the messages coming from terminals TER in natural language, and return corresponding knowledge when the subject of discussion of these messages is a request for information, for example. Typically, chatbot CRB may, in order to respond to a request for information, return previously stored knowledge, or alternatively may request the information from machine MA and then return it to terminals TER. Chatbot CRB may also convert a message received from the machine into knowledge and send it spontaneously to the participants in the chat room when necessary (in the case of an alert for example).

In its participation in the chat room, chatbot CRB may, by taking into account a specific set of rules, adopt a particular overall behavior having a chosen “personality” (for example acting dominant, or expressive, analytical, sympathetic, or other). This specific set of rules may be chosen and configured by an authorized user/administrator.

More generally, chatbot CRB may implement a configurable rules engine. For example, chatbot CRB may respond to requests from participants according to their “authorization” for interventions on the machine. Authorizations may be granted to users for the ability to send instructions to the machine or simply to access certain information coming from the machine. In this case, chatbot CRB may store a list of terminal identifiers (IMSI, IP address, or other) or users (login id, nickname, or other) having the authorization to send requests or to receive certain data from the machine, and otherwise to filter out these requests or data.

The filtering performed on the instructions to be applied to the machine may (additionally or alternatively) be based on other criteria. For example, chatbot CRB may also filter out a request from a terminal, normally authorized but for which the current geolocation shows that the user is too far from the machine to be able to send an appropriate operating instruction. Chatbot CRB may also filter out a request from a terminal, normally authorized but for which the timestamp does not correspond to a range of usual working hours (for example between 8 a.m. and 8 p.m. on weekdays).

It may be suspected that such an instruction could have been sent to the machine in an unjustified state of urgency and/or thoughtlessly. Chatbot CRB may also analyze an emotion in a message received from a user and may then filter out the request (for example an operating instruction) if it detects anger for example (an instruction sent for example in a state of annoyance, and possibly thoughtlessly) or fear (a hesitant and unsure instruction for example) in this message. Furthermore, if the message received from the user is a voice message, detection of this mood may be enhanced by detection of voice components in this voice message (for example an unusually high-pitched voice may reflect fear or possibly anger).

This invention thus provides security for the operation of the machine, as well as precision and speed in the response of the machine, while facilitating the user experience by means of the combination of natural language, artificial intelligence, and the providing of all the machine data. The user thus has easy interaction for controlling or even repairing the machine more quickly.

Of course, this invention is not limited to the embodiments described above by way of example; it extends to other variants.

Thus, for example, a chatbot has been described that is capable of dialogue with a machine on the basis of knowledge specific to this machine. In one embodiment, it is possible to provide several chatbots each capable of interacting with a machine, but also connected to a shared virtual room in which a team of users also participate, in order to control all of these machines in a coordinated manner.

Of course, the above use case of controlling a machine in a factory may have variants, for example such as in a home automation application, for coordinating the control of household devices by the members of a family, collaboratively.

1. A method of communication between several devices which include a machine and a plurality of user terminals, the method being implemented by a chatbot on a computing device as an interface between said several devices, the chatbot being able to communicate independently with the plurality of terminals and the machine, the plurality of user terminals running an instant messaging application in which the-users participate in a discussion with the chatbot by exchanging messages via their terminal, the method comprising at least:
analyzing at least one item of content in a message of a first type sent by at least one first device of the several devices, and
generating a message of a second type intended for a second device of the several devices, on the basis of the-results of the analysis of the message of the first type,
one among the at least one first device and second device being a user terminal of the plurality of user terminals and the other among the at least one first device and second device being the machine.

2. The method according to claim 1, wherein, generating the message of the second type comprises the chatbot, upon receiving the message of the first type coming from the machine:
accessing a knowledge database in order to identify a subject in the database linked to the content in the message of the first type coming from the machine, and
generating the message of the second type to be sent to at least some of the plurality of user terminals, the message of the second type comprising data from the knowledge database relating to said content.

3. The method according to claim 2, wherein said discussion is planned within a professional, collaborative setting, and the knowledge database includes information specific to a business sector of said collaborative work setting.

4. The method according to claim 1, wherein the message of the first type comes from at least one of the plurality of user terminals and includes a current request to be sent to the machine, and wherein the generation of the message of the second type intended for the machine includes:
identifying said current request in the message of the first type,
consulting a knowledge database in order to determine if the current request can be sent to the machine, and, if necessary, formulating the current request in an appropriate form, in the message of the second type.

5. The method according to claim 1, wherein the chatbot applies a filtering rule to prevent sending the message of the second type to the machine, at least based on data from the at least one first device, which comprises a transmitting user terminal of the plurality of user terminals, sending the message of the first type.

6. The method according to claim 5, wherein said data from the transmitting user terminal includes a terminal identifier which identifies the transmitting user terminal as belonging to a user authorized to send requests intended for the machine.

7. The method according to claim 5, wherein said data from the user terminal includes current geolocation data for the transmitting user terminal, and the filtering is applied if a distance between the transmitting user terminal and the machine is greater than a threshold.

8. The method according to claim 5, wherein said data from the transmitting user terminal includes current timestamp data sent by the transmitting user terminal with the message of the first type.

9. The method according to claim 5, wherein said data from the transmitting user terminal includes a score from the detection of a predetermined mood, identified in the message of the first type, and the filtering is applied if said score is above a threshold.

10. The method according to claim 9, wherein the message of the first type is a voice message, and the detection of said predetermined mood is enhanced by a detection of voice components in said voice message.

11. The method according to claim 1, wherein the chatbot applies a filtering rule to prevent sending a message of the second type to one of said plurality of user terminals if that user terminal is identified as belonging to a user not authorized to receive message content sent by the machine.

12. The method according to claim 1, wherein the chatbot analyzes a message received from a user terminal of the plurality of user terminals and/or generates a message intended for a user terminal of the plurality of user terminals, in natural language.

13. The method according to claim 1, wherein the chatbot analyzes a message received from the machine and/or generates a message intended for the machine, in formal language.

14. A non-transitory computer storage medium storing instructions of a computer program which when the program is executed by a processor configure the processor to implement a chatbot that executes a method of communication between several devices which include a machine and a plurality of user terminals, the chatbot interfacing between said several devices, the chatbot being able to communicate independently with the plurality of user terminals and the machine, the plurality of user terminals running an instant messaging application in which users participate in a discussion with the chatbot by exchanging messages via their terminal, the method comprising at least:
analyzing at least one item of content in a message of a first type sent by at least one first device of the several devices, and
generating a message of a second type intended for a second device of the several devices, on the basis of results of the analysis of the message of the first type,
one among the at least one first device and second device being a user terminal of the plurality of user terminals and the other among the at least one first device and second device being the machine.

15. A computing device comprising:
a communication interface for communicating with a machine, and with a plurality of user terminals (TER) running an instant messaging application, and
a processing circuit configured to implement a chatbot that executes a method of communication between several devices which include a machine and a plurality of user terminals, the chatbot interfacing between said several devices, the chatbot being able to communicate independently with the plurality of user terminals and the machine, the plurality of user terminals running an instant messaging application in which users participate in a discussion with the chatbot by exchanging messages via their terminal, the method comprising at least:
analyzing at least one item of content in a message of a first type sent by at least one first device of the several devices, and
generating a message of a second type intended for a second device of the several devices, on the basis of results of the analysis of the message of the first type,
one among the at least one first device and second device being a user terminal of the plurality of user terminals and the other among the at least one first device and second device being the machine.
